(19) United States
(12) Patent Application Publication
(10) Pub. No.: US 2016/0186733 A1
(43) Pub. Date: Jun. 30, 2016

(54) CONTROL VALVE FOR VARIABLE DISPLACEMENT COMPRESSOR

(71) Applicant: TGK CO., LTD., Tokyo (JP)

(72) Inventors: Ryota Sugamura, Tokyo (JP); Masaaki Tonegawa, Tokyo (JP); Hidekazu Sakakibara, Tokyo (JP)

(21) Appl. No.: 14/968,800

(22) Filed: Dec. 14, 2015

(30) Foreign Application Priority Data
Dec. 26, 2014 (JP) 2014-264996

(51) Int. Cl. F04B 27/18; F16K 31/06; F04B 17/05

(52) U.S. Cl. CPC F04B 27/1804; F04B 17/05; F16K 31/0658; F04B 2027/1854; F04B 2027/1845

(57) ABSTRACT

A control valve includes: a body having a port communicating with a discharge chamber, a port communicating with a control chamber, and a main valve hole formed in a passage connecting the ports; a main valve element configured to close and open a valve section by moving toward and away from the main valve hole; a solenoid configured to generate a force for driving the main valve element in valve opening and closing directions of the valve section, power supply to the solenoid being controlled according to pulse width modulation (PWM); and a vibration absorbing structure including a spring connected with a plunger configured to be displaced integrally with the main valve element, and a weight connected with the plunger with the spring therebetween in a relatively displaceable manner, and configured to suppress vibration of the main valve element caused by the PWM control.

### CLAIM OF PRIORITY

This application claims priority to Japanese Patent Application No. 2014-264996, filed on Dec. 26, 2014, of which is incorporated herein by reference.

### BACKGROUND OF THE INVENTION

1. Field of the Invention

The present invention relates to a control valve for controlling the discharging capacity of a variable displacement compressor.

2. Description of the Related Art

An automotive air conditioner is generally configured by arranging and placing a compressor, a condenser, an expander, an evaporator, and so forth in a refrigeration cycle. The compressor is, for example, a variable displacement compressor (hereinafter also referred to simply as “compressor”) capable of varying the refrigerant discharging capacity in order to maintain a constant level of cooling capacity irrespective of the engine speed. In this compressor, a piston for compression is linked to a wobble plate, which is mounted to a rotational shaft driven by an engine. The refrigerant discharging rate is regulated by changing the stroke of the piston through changes in the angle of the wobble plate. The angle of the wobble plate is changed continuously by changing the balance of pressure working on both faces of the piston as part of the discharged refrigerant is introduced into a hermetically-closed control chamber. The pressure within this control chamber (hereinafter referred to as “control pressure”) Pc is controlled by a control valve provided between the discharge chamber and the control chamber of the compressor.

Such a control valve is often structured as an electromagnetic valve, which has a valve hole in a body thereof, through which the discharge chamber and the control chamber communicate with each other. A valve element disposed inside the body is made to move toward and away from the valve hole to regulate the opening degree of a valve section and thus control the flow rate of refrigerant introduced into control chamber. The valve opening degree is regulated by a balance of a force caused by the refrigerant pressure acting on the valve element, the drive force of a solenoid, and the biasing force of a spring disposed for setting a control setting value. This control setting value may be adjusted afterward by changing the current value supplied to the solenoid. In view of reducing hysteresis in the valve opening characteristics, power saving, and so forth of such control valves, the pulse width modulation (PWM) is often employed for controlling power supply to the solenoid. For example, capacity control of some control valves is conducted by supplying a pulsed current with a frequency of about 400 Hz set at a predetermined duty ratio (refer to Japanese Patent Application Publication No. 2005-171908, for example).

### RELATED ART LIST

(1) Japanese Patent Application Publication No. 2005-171908

In such a control valve, however, the power supply control using the PWM causes micro vibration of a plunger of the solenoid, which may be transmitted to the valve element and thus to the body and cause noise.

### SUMMARY OF THE INVENTION

The present invention has been made in view of such circumstances, and a purpose thereof is to reduce noise caused by vibration of a plunger in a control valve for a variable displacement compressor in which power supply is controlled using the PWM.

One embodiment of the present invention relates to a control valve for varying a discharging capacity of a variable displacement compressor for compressing refrigerant introduced into a suction chamber and discharging the compressed refrigerant from a discharge chamber, the discharging capacity being varied by regulating the flow rate of refrigerant introduced from the discharge chamber to a control chamber or the flow rate of refrigerant delivered from the control chamber to the suction chamber. This control valve includes: a body having a first port communicating with the discharge chamber or the suction chamber, a second port communicating with the control chamber, and a valve hole formed in a passage connecting the first port and the second port; a valve element configured to close and open a valve section by moving toward and away from the valve hole; a solenoid configured to generate a force for driving the valve element in valve opening and closing directions of the valve section, power supply to the solenoid being controlled according to pulse width modulation (PWM); and a vibration absorbing structure including an elastic member connected with a movable member configured to be displaced integrally with the valve element, and a mass body connected with the movable member with the elastic member therebetween in a relatively displaceable manner, and configured to suppress vibration of the valve element caused by the PWM control.

By employing the embodiment, since a vibration absorbing structure is provided, the mass vibrates in a phase opposite to that of the valve element and cancels at least part of the inertia force of the valve element during the PWM control. As a result, noise caused by vibration of the plunger can be reduced.

### BRIEF DESCRIPTION OF THE DRAWINGS

FIG. 1 is a cross-sectional view illustrating a structure of a control valve according to a first embodiment;

FIG. 2 is a partially enlarged cross-sectional view of the upper half of FIG. 1;

FIG. 3 illustrates operation of the control valve;

FIG. 4 illustrates operation of the control valve;

FIGS. 5A to 5C illustrate a structure of a vibration absorbing structure according to a second embodiment;

FIG. 6 is a partial cross-sectional view illustrating a structure of a vibration absorbing structure and a structure therearound according to a third embodiment;

FIG. 7 is a partial cross-sectional view illustrating a structure of a vibration absorbing structure and a structure therearound according to a fourth embodiment;

FIGS. 8A and 8B illustrate a structure of a vibration absorbing structure according to a fifth embodiment;

FIG. 9 is a partial cross-sectional view illustrating a structure of a vibration absorbing structure and a structure therearound according to a sixth embodiment;

FIG. 10 is a partial cross-sectional view illustrating a structure of a vibration absorbing structure and a structure therearound according to a seventh embodiment; and

FIG. 11 is a cross-sectional view illustrating a structure of a control valve according to an eighth embodiment.

### DETAILED DESCRIPTION OF THE INVENTION

The invention will now be described by reference to the preferred embodiments. This does not intend to limit the scope of the present invention, but to exemplify the invention.

Embodiments of the present invention will now be described in detail with reference to the accompanying drawings. In the following description, for convenience of description, the positional relationship in each structure may be expressed as “vertical” or “up-down” with reference to how each structure is depicted in Figures.

### First Embodiment

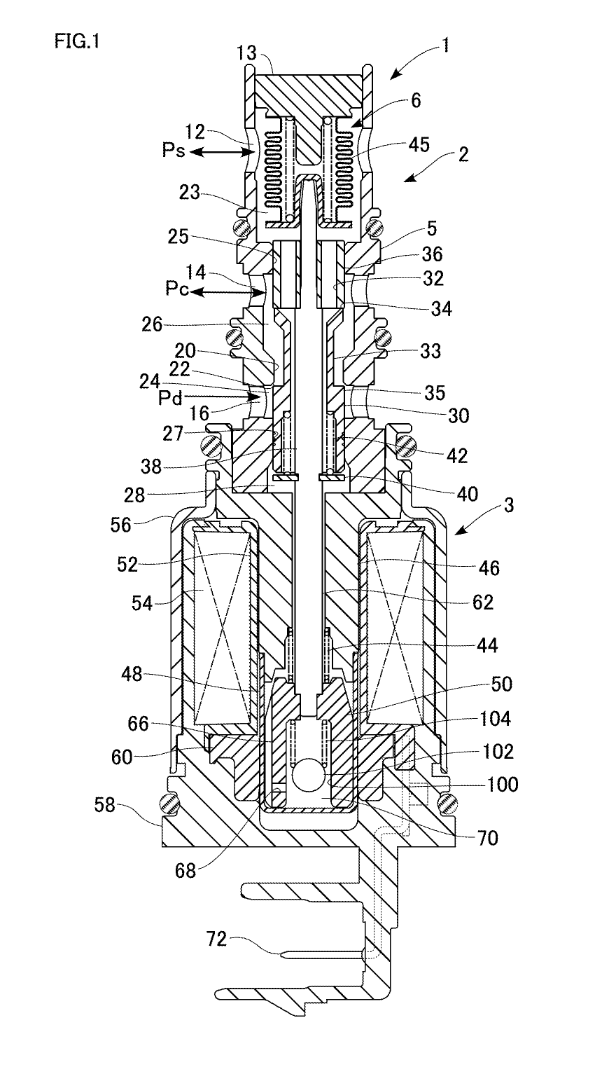

FIG. 1 is a cross-sectional view illustrating a structure of a control valve according to a first embodiment.

The control valve 1 is structured as an electromagnetic valve for controlling the discharging capacity of a not-shown variable displacement compressor (also referred to simply as a “compressor”) that is a device to be controlled and which is installed in a refrigeration cycle of an automotive air conditioner. The compressor compresses refrigerant flowing through the refrigeration cycle into a high-temperature and high-pressure gaseous refrigerant, and discharges the compressed gaseous refrigerant. The gaseous refrigerant is condensed by a condenser (external heat exchanger) and then adiabatically expanded by an expander into a low-temperature and low-pressure spay of refrigerant. The low-temperature and low-pressure refrigerant is evaporated by an evaporator, and the air inside the vehicle is cooled by the evaporative latent heat. The refrigerant evaporated by the evaporator is returned to the compressor and thus circulates through the refrigeration cycle. The compressor has a rotational shaft rotated by an engine of the automobile. A piston for compression is linked to a wobble plate mounted on the rotational shaft. The angle of the wobble plate is changed to change the stroke of the piston and to thus regulate the refrigerant discharging rate. The control valve 1 controls the flow rate of refrigerant introduced from the discharge chamber to the control chamber of the compressor to change the angle of the wobble plate and thus the discharging capacity of the compressor. Although the control chamber of the present embodiment is a crankcase, the control chamber may alternatively be a pressure chamber separately provided in or outside of the crankcase in a modification.

The control valve 1 is structured as a so-called Ps sensing valve for controlling the flow rate of refrigerant introduced from the discharge chamber into the control chamber so as to keep a suction pressure Ps (corresponding to a “sensed pressure”) of the compressor at a preset pressure. The control valve 1 is formed by an integral assembly of a valve unit 2 and a solenoid 3. The valve unit 2 includes a main valve for opening and closing a refrigerant passage through which part of discharged refrigerant is introduced into the control chamber while the compressor is in operation, and a sub-valve that functions as a so-called a bleed valve for letting refrigerant in the control chamber out to the suction chamber at the startup of the compressor. The solenoid 3 drives the main valve in an opening or closing direction to adjust the opening degree thereof and thus control the flow rate of refrigerant introduced into the control chamber. The valve unit 2 includes a stepped cylindrical body 5, the main valve and the sub-valve formed inside the body 5, a power element 6 for generating a counterforce against a force from the solenoid 3 (hereinafter also referred to as a solenoid force) to adjust the opening degree of the main valve, and so force. The power element 6 functions as a “sensing part.”

The body 5 has ports 12, 14, and 16 formed in this order from a top end thereof. The port 12 functions as a “suction chamber communication port” communicating with the suction chamber of the compressor. The port 14 functions as a “control chamber communication port” communicating with the control chamber of the compressor. The port 16 functions as a “discharge chamber communication port” communicating with the discharge chamber of the compressor. The port 16 also functions as a “first port”, and the port 14 also functions as a “second port”. An end member 13 is fixed to the body 5 in such a manner as to close an upper end opening of the body 5. A lower end part of the body 5 is connected to an upper end part of the solenoid 3.

Inside the body 5, a main passage that is an internal passage through which the port 16 and the port 14 communicate with each other and a sub-passage that is an internal passage through which the port 14 and the port 12 communicate with each other are formed. The main valve is provided in the main passage while the sub-valve is provided in the sub-passage. Thus, the control valve 1 has a structure in which the power element 6, the sub-valve, the main valve, and the solenoid 3 are arranged in this order from one end thereof. In the main passage, a main valve hole 20 and a main valve seat 22 are provided. In the sub-passage, a sub-valve hole 32 and a sub-valve seat 34 are provided.

The port 12 allows a working chamber 23 defined (formed) in an upper part of body 5 and the suction chamber to communicate with each other. The power element 6 is disposed in the working chamber 23. The port 16 allows refrigerant at a discharge pressure Pd from the discharge chamber to be introduced. A main valve chamber 24 is formed between the port 16 and the main valve hole 20, and the main valve is disposed therein. Refrigerant whose pressure is changed to a control pressure Pc through the main valve is delivered toward the control chamber through the port 14 during steady operation of the compressor, while refrigerant at the control pressure Pc discharged from the control chamber is introduced through the port 14 at the startup of the compressor. A sub-valve chamber 26 is formed between the port 14 and the main valve hole 20, and the sub-valve is disposed therein. Refrigerant at the suction pressure Ps is introduced through the port 12 during steady operation of the compressor, while refrigerant whose pressure is changed to the suction pressure Ps through the sub-valve is delivered toward the suction chamber through the port 12 at the startup of the compressor.

In other words, while the main valve is open, the port 16 functions as a “lead-in port” for introducing refrigerant from the discharge chamber and the port 14 functions as a “lead-out port” for delivering refrigerant toward the control chamber. In contrast, while the sub-valve is open, the port 14 functions as a “lead-in port” for introducing refrigerant from the control chamber, while the port 12 functions as a “lead-out port” for delivering refrigerant toward the suction chamber. The port 14 functions as a “lead-in/out port” for introducing or delivering refrigerant depending on the open or closed states of the main valve and the sub-valve.

The main valve hole 20 is formed between the main valve chamber 24 and the sub-valve chamber 26, and the main valve seat 22 formed at an end portion of a lower end opening of the main valve hole 20. A guiding passage 25 is formed between the port 14 and the working chamber 23 in the body 5. A guiding passage 27 is formed in a lower part (the part opposite to the main valve hole 20 with respect to the main valve chamber 24) of the body 5. A cylindrical main valve element 30 is slidably inserted in the guiding passage 27.

The main valve element 30 has an upper half part being reduced in diameter, extending through the main valve hole 20, and constituting a partition part 33 that separates inside from outside of the main valve element 30. A stepped portion formed at a middle part of the main valve element 30 constitutes a valve forming portion 35 that closes and opens the main valve by touching and leaving the main valve seat 22. The main valve element 30 touches and leaves the main valve seat 22 from the side of the main valve chamber 24 to close and open the main valve and thus control the flow rate of refrigerant flowing from the discharge chamber to the control chamber. The partition part 33 has an upper portion increasing upward in diameter into a tapered shape, and the sub-valve seat 34 is formed at an upper end opening of the partition part 33. The sub-valve seat 34 functions as a movable valve seat that displaces together with the main valve element 30.

A cylindrical sub-valve element 36 is inserted in the guiding passage 25. An internal passage of the sub-valve element 36 forms the sub-valve hole 32. The internal passage connects the sub-valve chamber 26 and the working chamber 23 with each other when the sub-valve is opened. The sub-valve element 36 and the sub-valve seat 34 are at positions facing each other along the axial direction. The sub-valve element 36 touches and leaves the sub-valve seat 34 in the sub-valve chamber 26 to close and open the sub-valve.

An elongated actuating rod 38 is also provided along the axis of the body 5. An upper end part of the actuating rod 38 extends through the sub-valve element 36 and is operably connected with the power element 6. A lower end part of the actuating rod 38 is connected to a plunger 50, which will be described later, of the solenoid 3. An upper half part of the actuating rod 38 extends through the main valve element 30, and has an upper portion being reduced in diameter. The sub-valve element 36 is mounted (outserted) around the reduced-diameter portion and fixed by press fitting. An end of the reduced-diameter portion is connected to the power element 6.

A ring-shaped spring support 40 is fit into and supported by a middle portion in the axial direction of the actuating rod 38. A spring 42 (functioning as a “biasing member”) for biasing the main valve element 30 in the closing direction of the main valve is mounted between the main valve element 30 and the spring support 40. During control of the main valve, the main valve element 30 and the spring support 40 are tensioned by the elastic force of the spring 42, and the main valve element 30 and the actuating rod 38 move integrally.

The power element 6 includes a bellows 45 that senses the suction pressure Ps and is displaced thereby. The displacement of the bellows 45 generates a counterforce against the solenoid force. The counterforce is also transmitted to the main valve element 30 via the actuating rod 38 and the sub-valve element 36. When the sub-valve element 36 touches the sub-valve seat 34 to close the sub-valve, the release of refrigerant from the control chamber to the suction chamber is blocked. When the sub-valve element 36 leaves the sub-valve seat 34 to open the sub-valve, the release of refrigerant from the control chamber to the suction chamber is permitted.

The solenoid 3 includes a stepped cylindrical core 46, a bottomed cylindrical sleeve 48 mounted in such a manner as to seal off a lower end opening of the core 46, a stepped cylindrical plunger 50 contained in the sleeve 48 and disposed opposite to the core 46 along the axial direction, a cylindrical bobbin 52 mounted (outserted) around the core 46 and the sleeve 48, an electromagnetic coil 54 wound around the bobbin 52 and configured to generate a magnetic circuit when power is supplied thereto, a cylindrical casing 56 provided in such a manner as to cover the electromagnetic coil 54 from outside, an end member 58 provided in such a manner as to seal off a lower end opening of the casing 56, and a collar 60 made of a magnetic material embedded in the end member 58 at a position below the bobbin 52. The core 46, the casing 56, and the collar 60 constitute a yoke. In addition, the body 5, the end member 13, the core 46, the casing 56, and the end member 58 constitute the body of the entire control valve 1.

The valve unit 2 and the solenoid 3 are secured in such a manner that the lower end part of the body 5 is press-fitted into an upper end opening of the core 46. A pressure chamber 28 is formed between the core 46 and the main valve element 30. The actuating rod 38 is inserted in and through the center of the core 46 in the axial direction. The suction pressure Ps introduced into the pressure chamber 28 is also introduced into the sleeve 48 via a communication passage 62 formed by a spacing between the actuating rod 38 and the core 46.

A spring 44 (functioning as a “biasing member”) for biasing the core 46 and the plunger 50 in directions away from each other is mounted therebetween. The spring 44 functions as a so-called off-spring. The actuating rod 38 is coaxially connected with each of the sub-valve element 36 and the plunger 50. The actuating rod 38 has an upper portion press-fitted into the sub-valve element 36 and a lower end portion press-fitted into the upper portion of the plunger 50. The actuating rod 38, the sub-valve element 36, and the plunger 50 constitute a “movable member” that is displaced integrally with the main valve element 30 during control of the main valve.

The actuating rod 38 appropriately transmits the solenoid force, which is a suction force generated between the core 46 and the plunger 50, to the main valve element 30 and the sub-valve element 36. At the same time, a drive force (also referred to as a “pressure-sensing drive force”) generated by an extraction/contraction movement of the power element 6 is exerted on the actuating rod 38 against the solenoid force. Thus, when the main valve is controlled, a force adjusted by the solenoid force and the pressure-sensing force acts on the main valve element 30 and appropriately controls the opening degree of the main valve. At the startup of the compressor, the actuating rod 38 is displaced relative to the body 5 against the biasing force of the spring 44 and according to the magnitude of the solenoid force, and lifts up the sub-valve element 36 to open the sub-valve after closing the main valve. Even during the control of the main valve, when the suction pressure Ps becomes substantially high, the actuating rod 38 is displaced relative to the body 5 against the biasing force of the bellows 45, and lifts up the sub-valve element 36 to open the sub-valve after closing the main valve. This achieves a bleeding function.

The sleeve 48 is made of a nonmagnetic material. A communicating groove 66 is formed in parallel with the axis on a lateral surface of the plunger 50, and a communicating hole 68 connecting the inside and the outside of the plunger 50 is provided in a lower portion of the plunger 50. Such a structure enables the suction pressure Ps to be introduced into a back pressure chamber 70 through a spacing between the plunger 50 and the sleeve 48 even when the plunger 50 is positioned at a bottom dead point as shown in FIG. 1.

A pair of connection terminals 72 connected to the electromagnetic coil 54 extend from the bobbin 52, and are led outside through the end member 58. For convenience of explanation, FIG. 1 shows only one of the pair of connection terminals 72. The end member 58 is installed in such a manner as to seal the entire structure inside the solenoid 3 contained in the casing 56 from below. The end member 58 is formed by molding (injection molding) a corrosion-resistant plastic material, and a spacing between the casing 56 and the electromagnetic coil 54 is also filled with the plastic material. With the spacing between the casing 56 and the electromagnetic coil 54 filled with the plastic material in this manner, heat generated by the electromagnetic coil 54 is easily conducted to the casing 56, which increases the heat release performance Ends of the connection terminals 72 are led out from the end member 58 and connected to a not-shown external power supply.

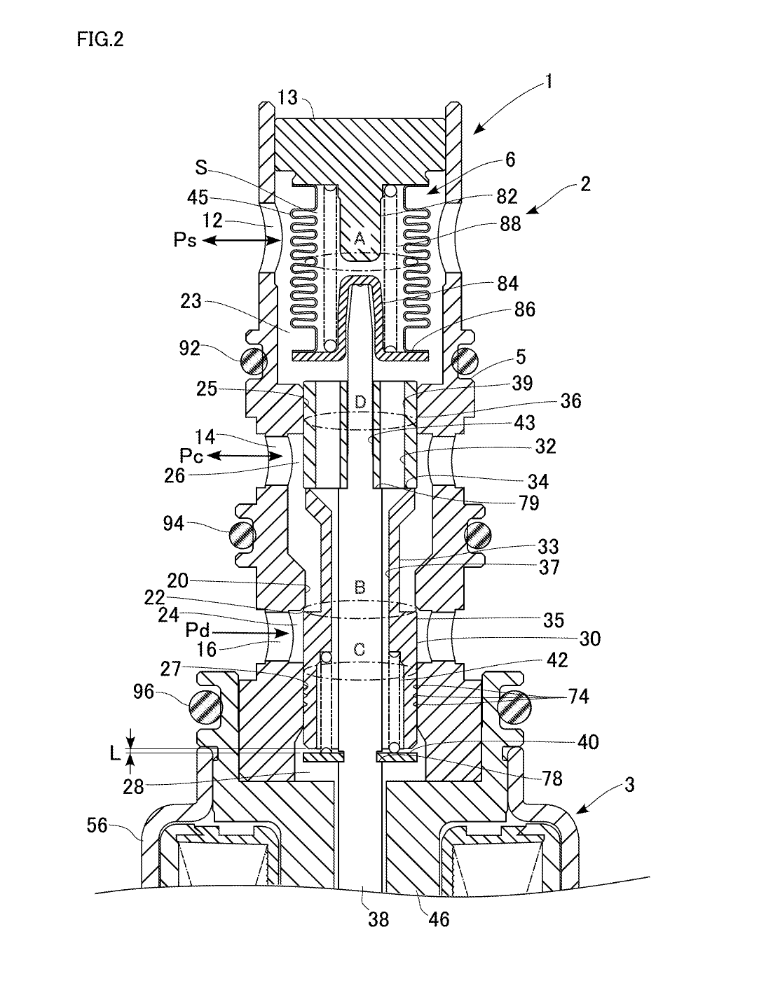

FIG. 2 is a partially enlarged cross-sectional view of the upper half of FIG. 1.

A labyrinth seal 74 having a plurality of annular grooves for restricting passage of refrigerant is formed on a sliding surface of the main valve element 30 sliding relative to the guiding passage 27. The spring support 40 is made of a so-called E-ring supported in such a manner as to be fitted into an annular groove formed in a middle part of the actuating rod 38 and located in the pressure chamber 28.

A lower half of the main valve element 30 has an enlarged inner diameter, and the spring 42 is disposed in such a manner as to be contained in the enlarged-diameter portion. With such a structure, since a contact point between the spring 42 and the main valve element 30 is located nearer to the main valve chamber 24 with respect to the center of a sliding portion of the guiding passage 27, the main valve element 30 is stably supported by the spring 42 in such a state as what is called a balancing toy. As a result, occurrence of hysteresis due to wobbling of the main valve element 30 being opened or closed can be prevented or reduced.

The sub-valve element 36 has an insertion hole 43 extending through the center thereof in the axial direction. An upper part of the actuating rod 38 extends through the insertion hole 43 up to the power element 6. The sub-valve element 36 is stopped by a stepped portion 79 that is a base end of the reduced-diameter portion of the actuating rod 38, so as to be positioned with respect to the actuating rod 38. A plurality of internal passages 39 for connecting an internal passage 37 of the main valve element 30 and the working chamber 23 with each other are formed around the insertion hole 43 of the sub-valve element 36. The internal passages 39 extend in parallel with the insertion hole 43 and pass through the sub-valve element 36. In the state shown in FIG. 2 in which the sub-valve element 36 is seated on the sub-valve seat 34, the stepped portion 79 of the actuating rod 38 is positioned so that the upper surface of the spring support 40 is separated from the lower surface of the main valve element 30 with at least a predetermined spacing L therebetween. The predetermined spacing L functions as a so-called “play (looseness)”.

As the solenoid force is increased, the actuating rod 38 can be displaced relative to the main valve element 30 to lift up the sub-valve element 36. This separates the sub-valve element 36 and the sub-valve seat 34 from each other and thus opens the sub-valve. In addition, the solenoid force can be directly transmitted to the main valve element 30 in a state in which the spring support 40 and the main valve element 30 are engaged (in contact) with each other, and the main valve element 30 can be pressed with a great force in the valve closing direction of the main valve. This structure functions as a lock release mechanism for releasing a locked state where the main valve element 30 is locked owing to a foreign material stuck between the sliding portions of the main valve element 30 and the guiding passage 27.

The main valve chamber 24 is a pressure chamber formed coaxially with the body 5 and having a larger diameter than the main valve hole 20. A relatively large space is thus formed between the main valve and the port 16, which can ensure a sufficient flow rate of refrigerant flowing through the main passage when the main valve is opened. Similarly, the sub-valve chamber 26 is a pressure chamber also formed coaxially with the body 5 and having a larger diameter than the main valve hole 20. Thus, a relatively large space is also formed between the sub-valve and the port 14. As illustrated in FIG. 2, an attachment and detachment portion between the upper end of the main valve element 30 and the lower end of the sub-valve element 36 is positioned in the middle of the sub-valve chamber 26. In other words, a movable range of the main valve element 30 is set so that the sub-valve seat 34 is always located in the sub-valve chamber 26, and the sub-valve is thus opened and closed inside the sub-valve chamber 26. This can ensure a sufficient flow rate of refrigerant flowing through the sub-passage when the sub-valve is opened. That is, the bleeding function can be effectively achieved.

The power element 6 includes a first stopper 82 closing an upper end opening of the bellows 45 and a second stopper 84 closing a lower end opening thereof. The bellows 45 functions as a “pressure sensing member”, and the first stopper 82 and the second stopper 84 function as “base members”. The first stopper 82 is integrally formed with the end member 13. The second stopper 84 is formed into a bottomed cylindrical shape by press forming a metal material, and has a flange portion 86 extending radially outward at the lower end opening thereof. The bellows 45 has an upper end of a bellows body welded to a lower surface of the end member 13 in an airtight manner, and a lower end opening of the bellows body is welded to an upper surface of the flange portion 86 in an airtight manner. The inside of the bellows 45 is a hermetically-sealed reference pressure chamber S, and a spring 88 for biasing the bellows 45 in a expanding (stretching) direction is disposed between the end member 13 and the flange portion 86 on an inner side of the bellows 45. The reference pressure chamber S is in a vacuum state in the present embodiment.

The end member 13 is a fixed end of the power element 6. The amount by which the end member 13 is press-fitted into the body 5 can be adjusted, so that a set load of the power element 6 (the set load of the spring 88) can be adjusted. The middle part of the first stopper 82 extends downward inward of the bellows 45, and the middle part of the second stopper 84 extends upward inward of the bellows 45, which form an axial core of the bellows 45. The upper end part of the actuating rod 38 is fitted to the second stopper 84. The bellows 45 expands (stretches) or contracts in the axial direction (in the opening/closing direction of the main valve and the sub-valve) according to a pressure difference between the suction pressure Ps in the working chamber 23 and a reference pressure in the reference pressure chamber S. A drive force in the valve opening direction is applied to the main valve element 30 with a displacement of the bellows 45. Even when the pressure difference becomes large, the second stopper 84 comes into contact with the first stopper 82 and stopped thereby when the bellows 45 has contracted by a predetermined amount, and the contraction is thus restricted.

In the present embodiment, an effective pressure receiving diameter A of the bellows 45, an effective pressure receiving diameter B (sealing diameter) of the main valve element 30 in the main valve, a sliding portion diameter C (sealing diameter) of the main valve element 30, and a sliding portion diameter D (sealing diameter) of the sub-valve element 36 are set to be equal. In the state in which the main valve element 30 and the power element 6 are operably connected with each other, the influences of the discharge pressure Pd, the control pressure Pc, and the suction pressure Ps acting on a combined unit of the main valve element 30 and the sub-valve element 36 connected with each other are thus cancelled. As a result, when the main valve is controlled, the main valve element 30 performs the valve opening or closing operation on the basis of the suction pressure Ps received by the power element 6 in the working chamber 23. That is, the control valve 1 functions as a so-called Ps sensing valve.

In the present embodiment, the influences of the pressures (Pd, Pc, and Ps) acting on the valve element can be cancelled by setting the diameters B, C, and D to be equal to one another and making the internal passage pass through the valve element (the main valve element 30 and the sub-valve element 36) vertically. Specifically, the pressures before and after (above and below in FIG. 2) a combined unit of the sub-valve element 36, the main valve element 30, the actuating rod 38, and the plunger 50 connected with one another can be set to an equal pressure (suction pressure Ps), which achieves pressure cancellation. As a result, the diameters of the valve elements can be set independent of the diameter of the bellows 45, which achieves high design flexibility. Thus, in a modification, while the diameters B, C, and D are set to be equal, the effective pressure receiving diameter A may be different therefrom. Specifically, the effective pressure receiving diameter A of the bellows 45 may be smaller than the diameters B, C, and D or larger than the diameters B, C, and D.

An O-ring 92 is fit into an outer surface of the body 5 between the port 12 and the port 14, and an O-ring 94 is fit into the outer surface between the port 14 and the port 16. Furthermore, an O-ring 96 is also fit into the outer surface near the upper end of the core 46. These O-rings 92, 94, and 96 have a sealing function, and restricts leakage of refrigerant when the control valve 1 is mounted in a mounting hole of the compressor.

Now refer back to FIG. 1. The plunger 50 has an insertion hole 100 that is open on a side opposite to a connection portion connected with the actuating rod 38, and a spherical weight 102 is supported in the insertion hole 100. The weight 102 is connected to the plunger 50 via a spring 104. The weight 102 functions as a “mass body”, and the spring 104 functions as an “elastic member”. The weight 102 and the spring 104 constitute a “vibration absorbing structure”. Note that the “vibration absorbing structure” mentioned herein includes the concepts of dynamic vibration absorbers and dynamic dampers.

One end of the spring 104 is connected to the plunger 50 while the other end thereof is connected to the weight 102. The weight 102 is thus supported in a cantilever fashion. While these connections are made by spot welding in the present embodiment, the connections may be made by other means such as brazing. As illustrated in FIG. 1, the weight 102, the spring 104, the plunger 50, and the actuating rod 38 are provided coaxially.

The spring 104 is a coiled spring having an outer diameter smaller than the inner diameter of the insertion hole 100. The diameter of the weight 102 is also smaller than the inner diameter of the insertion hole 100. The weight 102 can thus be displaced in the axial direction within the insertion hole 100 without interfering with the plunger 50. The spring 104 can expand and contract in the axial direction without interfering with the plunger 50. In addition, the position of the weight 102, the stiffness of the spring 104, the size of the sleeve 48, and so forth are set so that the weight 102 will not hit a bottom of the sleeve 48 even when the weight 102 vibrates because of the PWM control, which will be described later.

In such a structure, the natural frequency of the vibration absorbing structure based on the mass of the weight 102 and the spring constant of the spring 104 is set to be equal to a vibration frequency applied to the movable members (the plunger 50, the actuating rod 38, the main valve element 30, and the sub-valve element 36) by the PWM control. Note that “equal” mentioned herein is a concept including “substantially equal” as well as exactly equal. As a result, the weight 102 vibrates in a phase opposite to that of the vibration of the movable members, and an action cancelling the inertia force of the movable members is exerted. In a modification, the natural frequency of the vibration absorbing structure may have a value capable of suppressing vibration of the movable members due to the PWM control.

Next, operation of the control valve will be described.

In the present embodiment, the PWM is employed for controlling power supply to the solenoid 3. The PWM control is performed by a not-shown controller. The controller includes a PWM output unit configured to output a pulse signal with a specified duty ratio. Since a known configuration is used for the controller, detailed description thereof will be omitted.

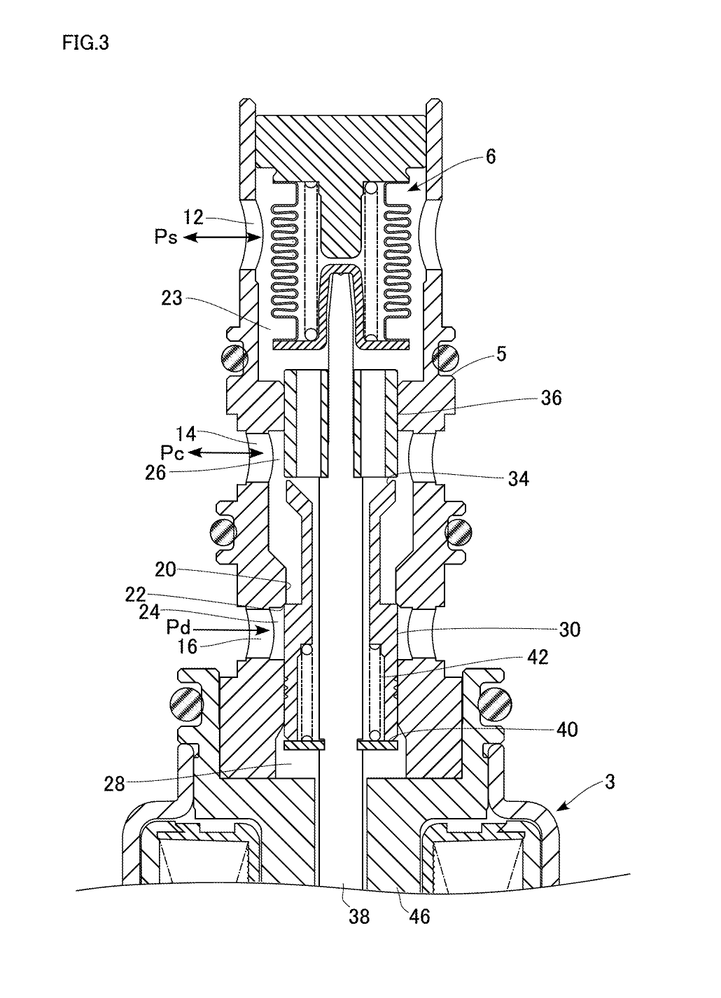

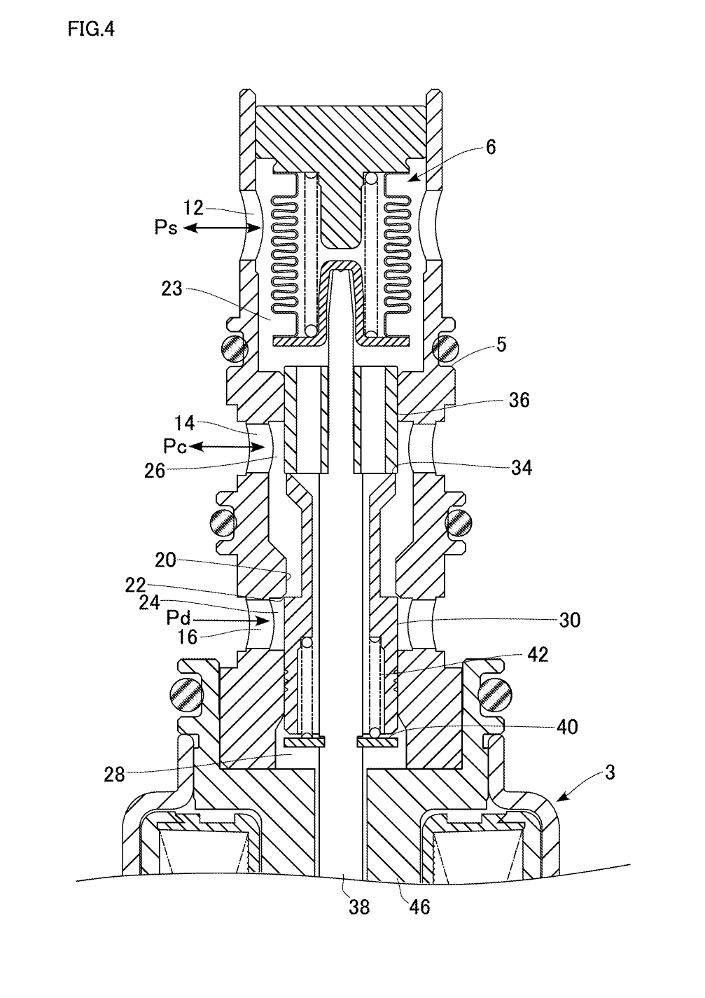

FIGS. 3 and 4 illustrate operation of the control valve. FIG. 2, which is described above, illustrates a minimum capacity operation state. FIG. 3 illustrates a state in which the bleeding function is made to work when the control valve is started or the like. FIG. 4 illustrates a relatively stable control state. Hereinafter, description will be given according to FIG. 1 with reference to FIGS. 2 to 4 where appropriate.

In the control valve 1, when the solenoid 3 is powered off, that is, when the automotive air conditioner is not in operation, the suction force does not act between the core 46 and the plunger 50. In the meantime, the biasing force of the spring 44 is transmitted to the main valve element 30 via the plunger 50, the actuating rod 38, and the sub-valve element 36. As a result, as illustrated in FIG. 2, the main valve element 30 is separated from the main valve seat 22 and the main valve becomes in a fully open state. In this process, the sub-valve remains in the closed state.

When a starting current is supplied to the electromagnetic coil 54 of the solenoid 3 at the startup of the automotive air conditioner, the sub-valve is opened as illustrated in FIG. 3 if the suction pressure Ps is higher than a valve opening pressure (also referred to as a “sub-valve opening pressure” set according to the supplied current value. Specifically, the solenoid force exceeds the biasing force of the spring 42, and the sub-valve element 36 is integrally lifted up. As a result, the sub-valve element 36 is separated from the sub-valve seat 34 and the sub-valve is opened, by which the bleeding function is effectively achieved. During this operation, the main valve element 30 is lifted up by the biasing force of the spring 42, and touches the main valve seat 22. As a result, the main valve is closed. Specifically, after the main valve is closed and introduction of discharged refrigerant into the control chamber is restricted, the sub-valve is opened and refrigerant in the control chamber is quickly released to the suction chamber. As a result, the compressor can be quickly started. Note that the “sub-valve opening pressure” changes with a change in a preset pressure Pₛₑₜ, which will be described later, depending on the environment of the vehicle.

When the current value supplied to the solenoid 3 is within a control current value range for the main valve, the opening degree of the main valve is autonomously regulated so that the suction pressure Ps becomes the preset pressure Pₛₑₜ set by the supplied current value. In this control state of the main valve, the sub-valve element 36 is seated on the sub-valve seat 34 and the sub-valve remains in the closed state as illustrated in FIG. 4. Since the suction pressure Ps is relatively low, the bellows 45 expands and the main valve element 30 moves to regulate the opening degree of the main valve. In this process, the main valve element 30 stops at a valve lifted position where the force in the valve opening direction generated by the spring 44, the force in the valve closing direction from the solenoid, and the force in the valve opening direction generated by the power element 6 depending on the suction pressure Ps are balanced.

When the refrigeration load is increased and the suction pressure Ps becomes higher than the preset pressure Pₛₑₜ, for example, the bellows 45 contracts, and the main valve element 30 is thus displaced relatively upward (in the valve closing direction). As a result, the valve opening degree of the main valve becomes smaller, and the compressor operates to increase the discharging capacity. Consequently, The suction pressure Ps changing in the lowering direction. Conversely, when the refrigeration load becomes smaller and the suction pressure Ps becomes lower than the preset pressure Pₛₑₜ, the bellows 45 expands. As a result, the power element 6 biases the main valve element 30 in the valve opening direction, increasing the valve opening degree of the main valve, and the compressor operates to reduce the discharging capacity. Consequently, suction pressure Ps is kept at the preset pressure Pₛₑₜ. If the suction pressure Ps becomes significantly higher than the preset pressure Pₛₑₜ, the main valve may be closed and the sub-valve may be opened depending on the magnitude of the suction pressure Ps. Since, however, there is a pressure range (dead zone) after the main valve is closed until the sub-valve is opened, such a situation in which the main valve and the sub-valve are opened and closed unsteadily is prevented.

If the engine load is increased while such steady control is performed and the load on the air conditioner is to be reduced, the solenoid 3 of the control valve 1 is switched off from the on state. Since the suction force then does not act between the core 46 and the plunger 50, the main valve element 30 is separated from the main valve seat 22 by the biasing force of the spring 44 and the main valve becomes in the fully open state. In this process, since the sub-valve element 36 is seated on the sub-valve seat 34, the sub-valve becomes in the valve closed state. As a result, refrigerant at the discharge pressure Pd introduced from the discharge chamber of the compressor to the port 16 passes through the fully open main valve and flows through the port 14 to the control chamber. Thus, the control pressure Pc becomes higher and the compressor operates with a minimum capacity.

Since the vibration absorbing structure described above functions in such control of the main valve, vibration of movable members caused by the PWM control can be suppressed, and generation of noise in the valve section and the body 5 can be reduced.

As described above, in the present embodiment, the vibration absorbing structure constituted by the weight 102 and the spring 104 is provided in series with the plunger 50. This can suppress vibration of the plunger 50 caused by the PWM control, and prevent or reduce hitting sound produced by the main valve element 30 hitting the main valve seat 22 when the main valve is slightly open, for example. This can also reduce vibration sound produced when the vibration of the plunger 50 is transmitted to the body 5. Thus, generation of noise associated with the PWM control can be prevented or reduced. Furthermore, since the weight 102 is disposed so as to be contained in the insertion hole 100 formed in the plunger 50, the effects of the vibration absorbing structure can be achieved without particularly increasing the size of the control valve 1. Furthermore, since the weight 102 operates with a clearance in the insertion hole 100 being maintained, there is also an advantage that friction or the like is not caused, which gives a longer lifetime to the vibration absorbing structure.

### Second Embodiment

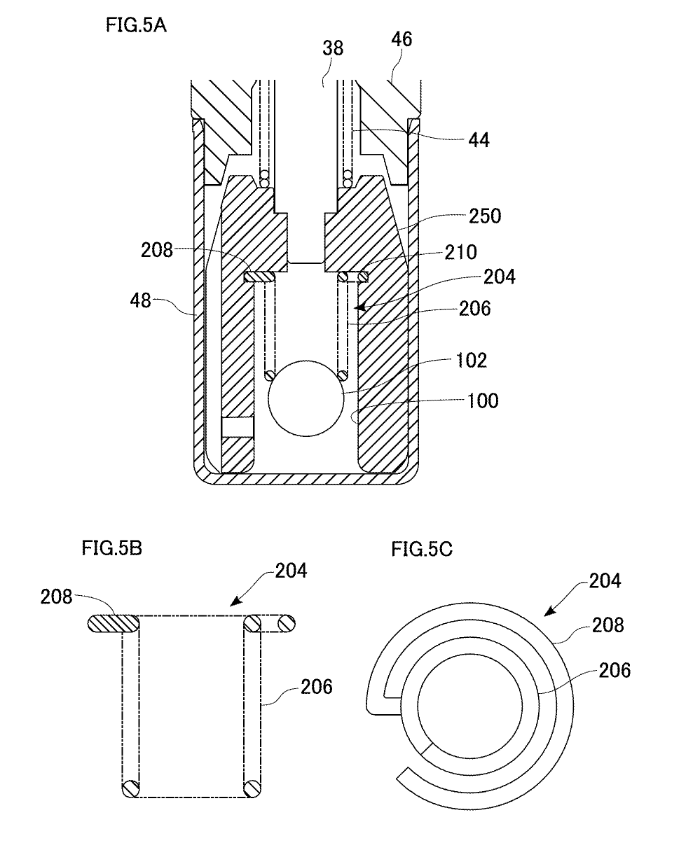

FIGS. 5A to 5C illustrate a structure of a vibration absorbing structure according to a second embodiment. FIG. 5A is a partial cross-sectional view illustrating a structure of the vibration absorbing structure and a structure therearound. FIG. 5B is a schematic cross-sectional view illustrating a structure of a spring; and FIG. 5C is a bottom view of the spring. The following description will focus on differences from the first embodiment. Components that are substantially the same as those in the first embodiment will be designated by the same reference numerals.

In the present embodiment, as illustrated in FIG. 5A, a spring 204 constituting the vibration absorbing structure and the plunger 250 are secured to each other in such a manner as to be fitted to each other. As illustrated in FIGS. 5B and 5C, the spring 204 has an annular fitting part 208 having a large diameter at an upper end of a coiled body 206 thereof.

On the other hand, as illustrated in FIG. 5A, an annular fitting groove 210 is formed in a lateral surface adjacent to a bottom of an insertion hole 100 of the plunger 250. The annular fitting part 208 is fitted to the fitting groove 210 so that the spring 204 is secured to the plunger 250. While the weight 102 and the spring 204 are secured to each other by spot welding similarly to the first embodiment, these may also be secured by a fitting structure. Such a structure facilitates assembly of the vibration absorbing structure.

### Third Embodiment

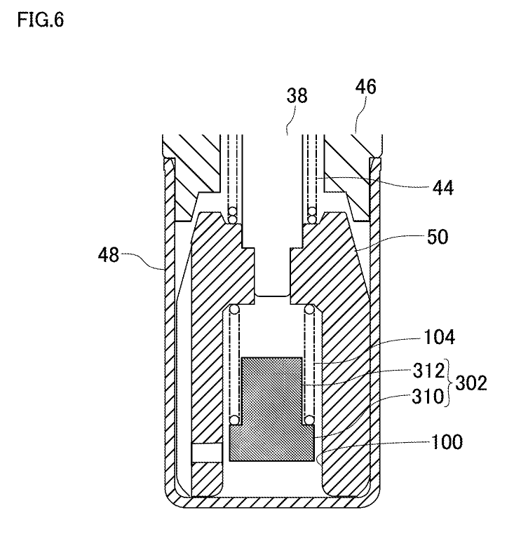

FIG. 6 is a partial cross-sectional view illustrating a structure of a vibration absorbing structure and a structure therearound according to a third embodiment. In the present embodiment, a weight 302 has a stepped columnar shape, and includes a body 310 to which an end of a spring 104 is connected and an insertion part 312 inserted in the spring 104. The insertion part 312 has a smaller outer diameter than the body 310, but is inserted deep toward the upper end of the spring 104, which can make the weight 302 as a whole larger in mass. In other words, an internal space of the insertion hole 100 can be effectively used to achieve a sufficient mass of the weight 302. That is, in setting the natural frequency of a member constituting the vibration absorbing structure, it is possible to adjust the mass of the weight 302 while saving space.

### Fourth Embodiment

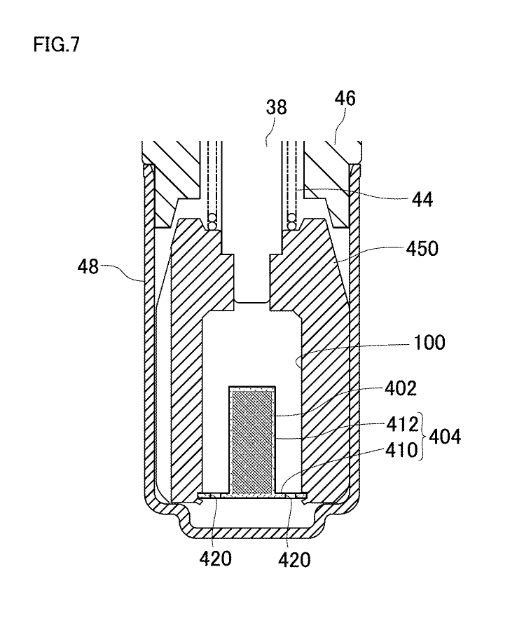

FIG. 7 is a partial cross-sectional view illustrating a structure of a vibration absorbing structure and a structure therearound according to a fourth embodiment. In the present embodiment, a diaphragm 404 made of rubber is used as an elastic member constituting the vibration absorbing structure. A weight 402 is formed by plastic molding in the diaphragm 404. Specifically, the diaphragm 404 includes a flexible, disc-shaped body 410 and a support part 412 that covers the weight 402 to support the weight 402 at the middle of the body 410. The body 410 has a plurality of communicating holes 420 for connecting the inside with the outside of the insertion hole 100. No communicating holes 68 as in the first embodiment are formed in the plunger 450. While an example in which the weight is molded in the diaphragm is presented in the present embodiment, the diaphragm may be integrated with the weight by other fixing means such as caulking a polyimide diaphragm.

An outer edge of the body 410 is caulked into a lower end of the plunger 450. The weight 402 has a columnar shape and extends inward in the insertion hole 100. The weight 402 is arranged coaxially with the plunger 450. Such a structure also enables effective use of the internal space of the insertion hole 100 and can achieve a sufficient mass of the weight 402.

### Fifth Embodiment

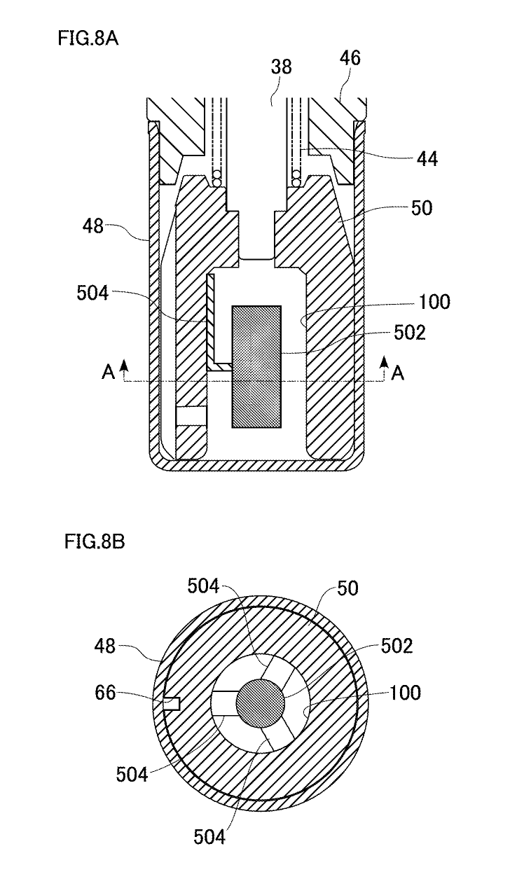

FIGS. 8A and 8B illustrate a structure of a vibration absorbing structure according to a fifth embodiment. FIG. 8A is a partial cross-sectional view illustrating a structure of the vibration absorbing structure and a structure therearound. FIG. 8B is a cross-sectional view along arrows A-A in FIG. 8B.

In the present embodiment, a plurality of (three in the present embodiment) leaf springs 504 are used as an elastic member constituting the vibration absorbing structure. These leaf springs 504 are provided at equal intervals around a columnar weight 502. The leaf springs 504 each have an L-shaped cross section. The shorter side of each of the leaf springs 504 extends in the radial direction of the weight 502 and the end thereof is connected with a middle part of the weight 502 in the axial direction. The longer side of each of the leaf springs 504 has a curved outer surface, which is connected with an inner surface of the insertion hole 100. While these connections are made by spot welding in the present embodiment, the connections may be made by other means such as brazing.

As a result of employing the leaf springs as the elastic member in this manner, the elastic member can be easily connected to a given position of the mass body (weight 502). Thus, the weight 502 can also be positioned around the center of the insertion hole 100 as illustrated, which enables effective use of the internal space of the insertion hole 100 and can achieve a sufficient mass of the weight 402. While an example in which each of the leaf springs 504 is connected with the weight 502 is presented in the present embodiment, a leaf spring having an annular body with a plurality of legs extending from an outer edge thereof may alternatively be used and the body may be connected with the weight 502, for example.

### Sixth Embodiment

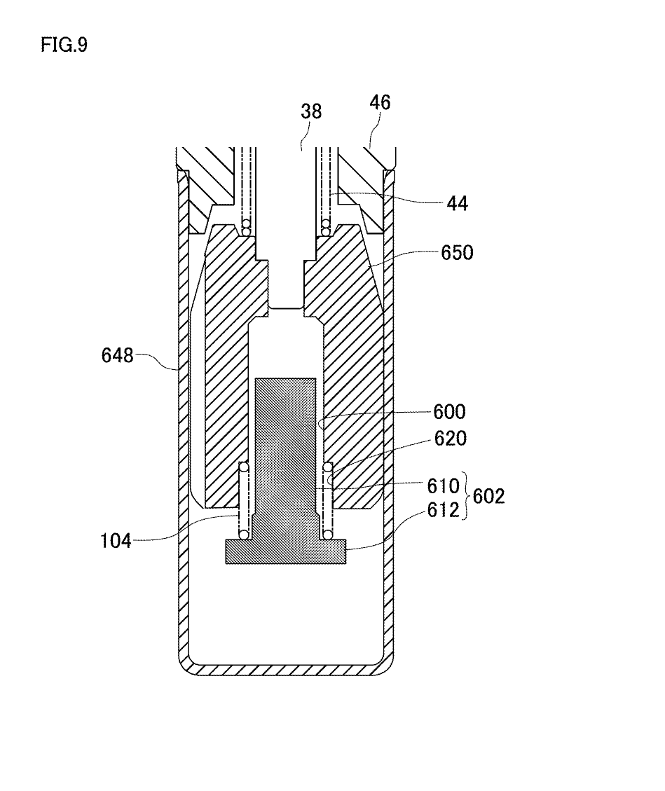

FIG. 9 is a partial cross-sectional view illustrating a structure of a vibration absorbing structure and a structure therearound according to a sixth embodiment. In the present embodiment, a structure in which part of a weight constituting the vibration absorbing structure protrudes outside of a plunger 650 is employed. A sleeve 648 is thus larger in size in the axial direction than the sleeve 48 of the first embodiment.

The plunger 650 has an insertion hole 600 with an enlarged-diameter portion 620 at a lower part thereof, in which a great part of the weight 602 is inserted. The weight 602 has a stepped columnar shape having a body 610 inserted in the insertion hole 600 and a large-diameter portion 612 exposed outside of the insertion hole 600. A spring 104 is provided between a base end of the enlarged-diameter portion 620 and the large-diameter portion 612. The large-diameter portion 612 has an outer diameter larger than the inner diameter of the enlarged-diameter portion 620.

As a result of making the weight 602 partially extend outside of the plunger 650 in this manner, the mass of the weight 602 can be increased. That is, in setting the natural frequency of the vibration absorbing structure, the weight 602 can be more easily adjusted.

### Seventh Embodiment

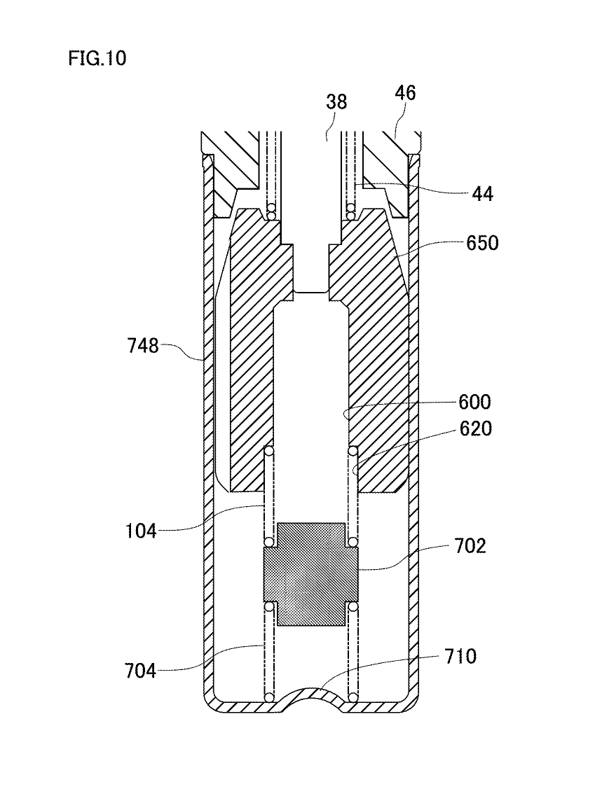

FIG. 10 is a partial cross-sectional view illustrating a structure of a vibration absorbing structure and a structure therearound according to a seventh embodiment. In the present embodiment, the entire weight constituting the vibration absorbing structure is placed outside of a plunger 650.

The weight 702 has a stepped columnar shape supported between a pair of springs 104 and 704 from above and below. The spring 104 is provided between an enlarged-diameter portion 620 of the plunger 650 and the weight 702. The spring 704 is provided between a bottom of a sleeve 748 and the weight 702. The sleeve 748 has a spring support portion 710 protruding inward at the middle of the bottom in such a manner that the spring support portion 710 functions as an axial core of the spring 704. Such a structure eliminates the need of securing the weight 702 to the springs 104 and 704 by welding or the like, and thus facilitates assembly of the vibration absorbing structure.

### Eighth Embodiment

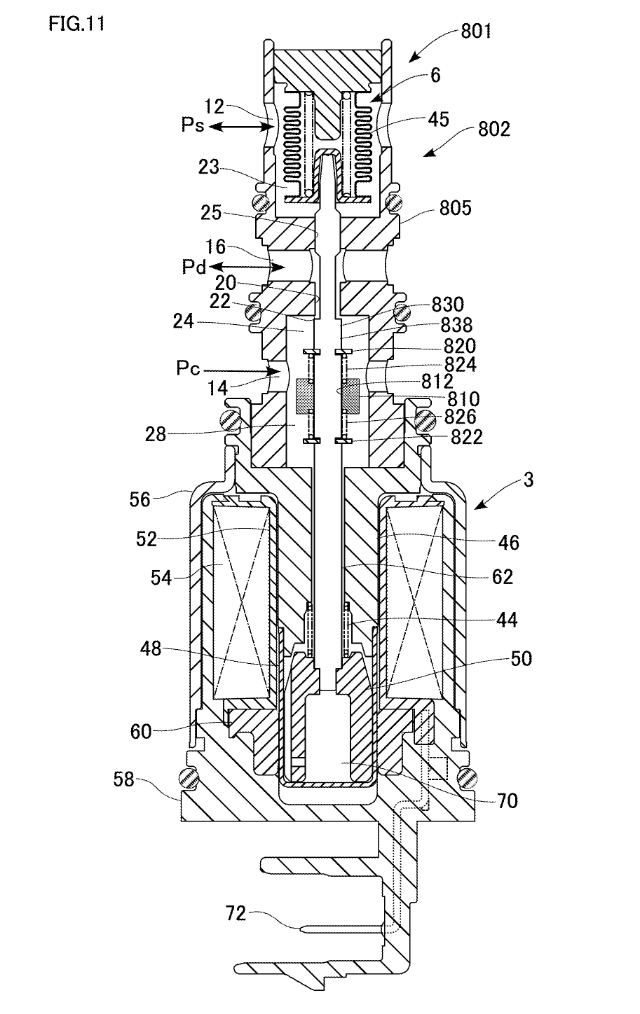

FIG. 11 is a cross-sectional view illustrating a structure of a control valve according to an eighth embodiment.

Unlike the first embodiment, a control valve 801 has no sub-valve for providing a bleeding function. In addition, a vibration absorbing structure is not provided in a solenoid 3 but provided in a valve unit 802. The vibration absorbing structure is connected with an actuating rod 838. The actuating rod 838 has a stepped columnar shape, where an upper part thereof extends slidably through a guiding passage 25. A valve element 830 is provided integrally with the actuating rod 838. The vibration absorbing structure is positioned in a pressure chamber 28 surrounded by a lower half of a body 805 and the solenoid 3.

Specifically, an annular weight 810 is provided in such a manner as to be mounted (outserted) around a middle portion of the actuating rod 838. Note that a sufficient clearance is set between an insertion hole 812 through the weight 810 and the actuating rod 838, which achieves a structure in which the weight 810 is not subjected to sliding friction with the actuating rod 838. A spring support 820 is provided on the actuating rod 838 above the weight 810, and a spring support 822 is provided on the actuating rod 838 below the weight 810. A spring 824 is provided between the weight 810 and the spring support 820, and a spring 826 is provided between the weight 810 and the spring support 822. These springs 824 and 826 function as an “elastic member” and constitutes the vibration absorbing structure together with the weight 810.

In the present embodiment as well, the natural frequency of the vibration absorbing structure based on the mass of the weight 810 and the spring constants of the springs 824 and 826 is set to be equal to the vibration frequency applied to movable members (the plunger 50, the actuating rod 838, and the valve element 830) by the PWM control. The weight 810 thus vibrates in a phase opposite to that of the vibration of the movable members, and an action cancelling the inertia force of the movable members is exerted. As a result, vibration of the plunger 50 caused by the PWM control can be suppressed, and generation of noise can be prevented or reduced.

The description of the present invention given above is based upon illustrative embodiments. These embodiments are intended to be illustrative only and it will be obvious to those skilled in the art that various modifications could be further developed within the technical idea underlying the present invention.

While some examples of arrangement of the vibration absorbing structure have been presented in the embodiments described above, other arrangements may be employed. For example, a vibration absorbing structure may be provided between a plunger and a core. Alternatively, a vibration absorbing structure may be provided between a power element and an actuating rod.

In the embodiments described above, the control valve for inflow control for regulating the flow rate of refrigerant introduced from the discharge chamber to the control chamber of the variable displacement compressor has been presented. In a modification, a control valve may be used for outflow control for regulating the flow rate of refrigerant delivered from the control chamber to the suction chamber. In this case, a main valve hole is formed in a passage connecting a suction chamber communication port and a control chamber communication port. A main valve element moves toward and away from the main valve hole to close and open a main valve. There is no need to provide a sub-valve.

In the embodiments described above, the so-called Ps sensing valve including the power element 6 placed in the working chamber 23 filled with the suction pressure Ps and operating upon directly sensing the suction pressure Ps has been presented as the control valve. In a modification, a Ps sensing valve including a power element placed in a capacity chamber filled with the control pressure Pc and having a structure for cancelling the control pressure Pc to substantially sensing the suction pressure Ps may be used. Alternatively, the control valve may be a so-called Pc sensing valve operating upon sensing the control pressure Pc as the sensed pressure instead of the suction pressure Ps. Alternatively, the control valve may be a differential pressure regulating valve having no power element and operating upon sensing a pressure difference by movable members including a valve element. For example, the control valve may be a Pd−Ps differential pressure regulating valve operating so that the pressure difference (Pd−Ps) between the discharge pressure Pd and the suction pressure Ps becomes a preset pressure difference. Alternatively, the control valve may be a Pd−Pc differential pressure regulating valve operating so that the pressure difference (Pd−Pc) between the discharge pressure Pd and the control pressure Pc becomes a preset pressure difference.

While an example in which the bellows 45 is used as the pressure sensing member constituting the power element 6 has been described in the embodiment described above, a diaphragm may be used instead. In this case, a plurality of diaphragms may be connected in the axial direction to achieve operating strokes required for a pressure sensing member.

While springs have been presented as biasing members (elastic members) in relation to the springs 42, 44, 88, 104, 204, 504, 824, 826, etc. in the embodiments described above, it goes without saying that elastic materials such as rubber and plastics may be used instead.

While the reference pressure chamber S inside the bellows 45 is in a vacuum state in the embodiment described above, the reference pressure chamber S may be filled with air or a predetermined reference gas. Alternatively, the reference pressure chamber S may be filled with any one of the discharge pressure Pd, the control pressure Pc, and the suction pressure Ps. The power element may thus operate upon sensing a pressure difference between the inside and the outside of the bellows as appropriate. Furthermore, while the structure in which the pressures Pd, Pc, and Ps directly received by the main valve element are cancelled is presented in the embodiments described above, a structure in which at least one of these pressures is not cancelled may be used.

In the first embodiment described above, the structure in which the suction chamber communication port, the control chamber communication port, and the discharge chamber communication port are formed in this order from one end (opposite to the solenoid) of the body, where the discharge chamber communication port positioned adjacent to the solenoid, has been presented. In the second embodiment described above, the structure in which the suction chamber communication port, the discharge chamber communication port, and the control chamber communication port are formed in this order from one end of the body, where the control chamber communication port is positioned adjacent to the solenoid, has been presented. In a modification, an arrangement of ports other than the above may be employed. For example, the suction chamber communication port may be positioned adjacent to the solenoid.

The present invention is not limited to the above-described embodiments and modifications only, and the components may be further modified to arrive at various other embodiments without departing from the scope of the invention. Various other embodiments may be further formed by combining, as appropriate, a plurality of structural components disclosed in the above-described embodiments and modification. In addition, one or some of all of the components exemplified in the above-described embodiments and modifications may be left unused or removed.

What is claimed is:

1. A control valve for a variable displacement compressor for varying a discharging capacity of the compressor for compressing refrigerant introduced into a suction chamber and discharging the compressed refrigerant from a discharge chamber, by regulating a flow rate of refrigerant introduced from the discharge chamber to a control chamber or a flow rate of refrigerant delivered from the control chamber to the suction chamber, the control valve comprising:
a body having a first port communicating with the discharge chamber or the suction chamber, a second port communicating with the control chamber, and a valve hole formed in a passage connecting the first port and the second port;
a valve element configured to close and open a valve section by moving toward and away from the valve hole;
a solenoid configured to generate a force for driving the valve element in valve opening and closing directions of the valve section, power supply to the solenoid being controlled according to pulse width modulation; and
a vibration absorbing structure including an elastic member connected with a movable member configured to be displaced integrally with the valve element, and a mass body connected with the movable member with the elastic member therebetween in a relatively displaceable manner, and configured to suppress vibration of the valve element caused by the control according to the pulse width modulation.

2. A control valve for a variable displacement compressor according to claim 1, further comprising an actuating rod for transmitting the force from the solenoid to the valve element,
wherein the solenoid includes:
a core secured to the body; and
a plunger disposed opposite to the core along an axial direction, connected with the valve element via the actuating rod, and being displaceable integrally with the valve element in the axial direction,
wherein the elastic member is connected with at least one of the plunger and the actuating rod as the movable member.

3. A control valve for a variable displacement compressor according to claim 2,
wherein at least part of the mass body is inserted in an insertion hole formed in the plunger, and
wherein the mass body is supported by the elastic member in a manner displaceable relative to the plunger in the axial direction.

4. A control valve for a variable displacement compressor according to claim 2,
wherein the elastic member is a spring, and
wherein one end of the spring is connected with the plunger, and an other end of the spring is connected with the mass body.

5. A control valve for a variable displacement compressor according to claim 3,
wherein the elastic member is a spring, and
wherein one end of the spring is connected with the plunger, and an other end of the spring is connected with the mass body.

6. A control valve for a variable displacement compressor according to claim 2,
wherein the elastic member is a diaphragm, and
wherein the mass body is formed integrally with the diaphragm.

7. A control valve for a variable displacement compressor according to claim 2,
wherein the plunger, the actuating rod, and the mass body are arranged coaxially, and
wherein the mass body is disposed opposite to the actuating rod with respect to the plunger.

8. A control valve for a variable displacement compressor according to claim 3,
wherein the plunger, the actuating rod, and the mass body are arranged coaxially, and
wherein the mass body is disposed opposite to the actuating rod with respect to the plunger.

9. A control valve for a variable displacement compressor according to claim 4,
wherein the plunger, the actuating rod, and the mass body are arranged coaxially, and
wherein the mass body is disposed opposite to the actuating rod with respect to the plunger.

10. A control valve for a variable displacement compressor according to claim 5,
wherein the plunger, the actuating rod, and the mass body are arranged coaxially, and
wherein the mass body is disposed opposite to the actuating rod with respect to the plunger.

11. A control valve for a variable displacement compressor according to claim 2,
wherein the mass body is disposed in a space surrounded by the body and the solenoid, and connected with the actuating rod as the movable member.

12. A control valve for a variable displacement compressor according to claim 1,
wherein a natural frequency of the vibration absorbing structure based on a mass of the mass body and an elastic constant of the elastic member is made equal to a vibration frequency applied to the movable member in the control according to the pulse width modulation.

13. A control valve for a variable displacement compressor according to claim 2,
wherein a natural frequency of the vibration absorbing structure based on a mass of the mass body and an elastic constant of the elastic member is made equal to a vibration frequency applied to the movable member in the control according to the pulse width modulation.

14. A control valve for a variable displacement compressor according to claim 3,
wherein a natural frequency of the vibration absorbing structure based on a mass of the mass body and an elastic constant of the elastic member is made equal to a vibration frequency applied to the movable member in the control according to the pulse width modulation.

15. A control valve for a variable displacement compressor according to claim 4,
wherein a natural frequency of the vibration absorbing structure based on a mass of the mass body and an elastic constant of the elastic member is made equal to a vibration frequency applied to the movable member in the control according to the pulse width modulation.

16. A control valve for a variable displacement compressor according to claim 5,
wherein a natural frequency of the vibration absorbing structure based on a mass of the mass body and an elastic constant of the elastic member is made equal to a vibration frequency applied to the movable member in the control according to the pulse width modulation.

17. A control valve for a variable displacement compressor according to claim 7,
wherein a natural frequency of the vibration absorbing structure based on a mass of the mass body and an elastic constant of the elastic member is made equal to a vibration frequency applied to the movable member in the control according to the pulse width modulation.

18. A control valve for a variable displacement compressor according to claim 8,
wherein a natural frequency of the vibration absorbing structure based on a mass of the mass body and an elastic constant of the elastic member is made equal to a vibration frequency applied to the movable member in the control according to the pulse width modulation.

19. A control valve for a variable displacement compressor according to claim 9,
wherein a natural frequency of the vibration absorbing structure based on a mass of the mass body and an elastic constant of the elastic member is made equal to a vibration frequency applied to the movable member in the control according to the pulse width modulation.

20. A control valve for a variable displacement compressor according to claim 10,
wherein a natural frequency of the vibration absorbing structure based on a mass of the mass body and an elastic constant of the elastic member is made equal to a vibration frequency applied to the movable member in the control according to the pulse width modulation.
